(19) United States
(12) Patent Application Publication
(10) Pub. No.: US 2014/0323207 A1
(43) Pub. Date: Oct. 30, 2014

(54) Methods and Systems for Managing a Multi-Line Sportsbook

(71) Applicant: NINJA, LLC, Honolulu, HI (US)

(72) Inventor: Adam Jae Chun Lee, Honolulu, HI (US)

(73) Assignee: NINJA, LLC, Honolulu, HI (US)

(21) Appl. No.: 14/262,637

(22) Filed: Apr. 25, 2014

Related U.S. Application Data
(60) Provisional application No. 61/816,698, filed on Apr. 26, 2013.

(51) Int. Cl. G07F 17/32

(52) U.S. Cl. CPC G07F 17/3244
USPC 463/25

(57) ABSTRACT

A computer-implemented method for generating wagers between a user of a user computing device and a multiple sportsbooks system is provided. The method is implemented by a host computing device coupled to a memory. The method includes receiving, by the host computing device, a first data feed from a first sportsbook and a second data feed from a second sportsbook. The first data feed includes first wagering data associated with an event and the second data feed includes second wagering data associated with the event. The method also includes providing a proposition to the user computing device based at least in part on the first wagering data and the second wagering data. The method further includes generating, by the host computing device, a wager between the user and the multiple sportsbook system. The wager is associated with the proposition.

### CROSS-REFERENCE TO RELATED APPLICATIONS

This application claims priority to provisional application No. 61/816,698 filed Apr. 26, 2013, and incorporates the contents of that application by reference in its entirety.

### BACKGROUND OF THE DISCLOSURE

A sportsbook is a ledger of gambling wagers for sporting events. The sport can be any sport and traditionally is one of football, baseball, basketball, hockey, soccer, horse racing, or any other sport in which participants compete and an outcome or result is determined. The sportsbook is maintained by a “bookie”, typically an employee of a casino. Traditionally, when a bettor wishes to make a bet he approaches the bookie, reviews the sportsbook and places his wager. Known sportsbooks accept various types of wagers based on the probability of a particular outcome associated with the event occurring. In one example, such as in horseracing, a wager on an outcome that is considered likely to occur, e.g., the favored horse winning the race, is payed out at a reduced rate compared to a wager on an outcome that is considered unlikely to occur, e.g., a disfavored, or underdog, horse winning the race. The payout ratio of a winning wager, hereinafter referred to as the “payout odds,” entices bettors to bet on both favored and disfavored outcomes. In another example, known sportsbooks provide a point-spread wager where the odds for either team winning in a sporting event are substantially equal once the point spread is taken into account. More specifically, a point-spread substantially evens out the probability of either team winning an event by giving points, or other advantages to the underdog. Other types of bets include money line, parlays, teasers, teaser parlays, proposition bets and a hybrid of money line/spread bets such as buying or giving up extra points. The sportsbooks offer one set of point-spreads or lines to their customers via a physical sportsbook in a casino or mobile access within legal jurisdictions, and the customers chooses their bets based on that one set of points spreads.

Over time, casinos developed in many locations and began to provide many different sportsbooks, with one sportsbook associated with each casino that is licensed to have a sportsbook. The sportsbooks typically have similar odds and lines, but they are not identical creating a chance for an advantage or a disadvantage for the sports bettor depending on their access to different point-spreads, lines and sportsbooks. The differences may allow bettors an advantage in one casino over another.

Currently, bettors can go to other sportsbooks and view different sets of point-spreads or lines to bet on but no sportsbook offers more than one point-spread or line to bet on since they would take the risk of losing both sides of a bet. A common strategy for bettors is try and play the ‘middle’, which means betting on both teams with different point-spreads and trying to win both bets when the result of the event is in between the two bets, or the ‘middle’. To reduce losses from bettors betting the ‘middle’, sportsbooks only offers bettors only have access to one set of point-spreads and lines available at their current physical position or dedicated mobile app instead of being able to bet all the lines from one convenient location, physical or mobile. By offering one line per sportsbooks to bettors, the bettors may not be getting the best point-spread or line across all sportsbooks. This advantage facilitates generating a stream of revenue for the sportsbook. On average this can be highly lucrative for the casino and costly for the bettor.

Also, another concern is the ability to offer a sportsbook. Casinos typically do not allow bettors to create their own sportsbooks as allowing other sportsbooks will create competition and potentially take away business from the casino.

The foregoing examples of the related art and limitations related therewith are intended to be illustrative and not exclusive. Other limitations of the related art will become apparent upon a reading of the specification and a study of the drawings.

### BRIEF DESCRIPTION OF THE DISCLOSURE

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A system offers bettors the ability to view multiple sportsbooks and their point-spreads and lines, and allows bettors to place a bet or bets on the best point-spread and lines for a game or variety of games from one account. In at least one embodiment, the system may enable a user to place a plurality of bets on a plurality of games from multiple sportsbooks from the one account. The system may also allow bettors to participate by creating their own sportsbooks as well. The system receives incoming data from sportsbook data feeds and stores this data into a data repository. Users creating their own sportsbooks or “playing-as-house” also provide data directly into the system.

The system then provides this data to bettors via an interface. The bettors can view the multiple sportsbooks including searching by their preference and enter their wagers on one or more sportsbooks. At the time of betting the bettors can receive live data updates and alerts from casinos as the data is received which can do things like alert a sports better of a better line than the one they have chosen, or alert the sports bettor that a point-spread changing has occurred on a game. This will give sports bettors the most current information related to sports betting and the best chance to win in the sort and long term. In at least one embodiment, the bettor may select which alerts to receive and/or set a threshold on the point spread changes with which to receive an alert.

The system manages funding, including receiving user funds and managing payments. The system includes interfaces into various managers that control fund transfers and related information. The system allows multiple sportsbooks to have an account on the system with a running balance and allowing users to create an account with a deposit and keep a running balance. All bets from each user are tracked according to the result and the sportsbook that the bet was placed, and accounts are reconciled and adjusted accordingly. For example, a first sportsbook may have a first account and a second sportsbook may have a second account. When a user makes a bet with both sportsbooks through the system the user's account is deducted according to the sum of all wagers, while the first account and the second account are reduced according to the bets associated with their respective lines. Once a winner is determined, the funds are automatically reconciled and transferred to the winner of the bet.

Methods of managing sportsbook data and presenting the data to users allow bettors to make wagers and/or operate their own sportsbook. Related methods control funds transfers and storage of related information.

A computer-implemented method for generating at least one wager between a user of a user computing device and a multiple sportsbooks system is provided. The method is implemented by a host computing device coupled to a memory. The method includes receiving, by the host computing device, a first data feed from a first sportsbook and a second data feed from a second sportsbook. The first data feed includes first wagering data associated with an event and the second data feed includes second wagering data associated with the event. The method also includes providing a proposition to the user computing device based at least in part on the first wagering data and the second wagering data. The method further includes generating, by the host computing device, a wager between the user and the multiple sportsbook system. The wager is associated with the proposition.

A host computing device for generating wagers between a user of a user computing device and a multiple sportsbooks system is provided. The host computing device includes a memory and a processor coupled to the memory. The processor is configured to receive a first data feed from a first sportsbook and a second data feed from a second sportsbook. The first data feed includes first wagering data associated with an event and the second data feed includes second wagering data associated with the event. The processor is further configured to provide at least one proposition to the user computing device based at least in part on the first wagering data and the second wagering data. The processor is further configured to generate a wager between the user and the multiple sportsbook system. The wager is associated with the at least one proposition.

A computer readable medium having computer-executable instructions for generating wagers between a user of a user computing device and a multiple sportsbooks system is provided. When executed by a processor, the computer-executable instructions cause the processor to receive a first data feed from a first sportsbook and a second data feed from a second sportsbook. The first data feed includes first wagering data associated with an event and the second data feed includes second wagering data associated with the event. The computer-executable instructions further cause the processor to provide at least one proposition to the user computing device based at least in part on the first wagering data and the second wagering data. The computer-executable instructions further cause the processor to generate a wager between the user and the multiple sportsbook system. The wager is associated with the at least one proposition.

### BRIEF DESCRIPTION OF THE DRAWINGS

FIG. 1 depicts an example of a system for managing multiple sportsbooks.

FIG. 2 depicts an example of a system for sportsbooks data intake.

FIG. 3 depicts an example of a system for managing data for multiple sportsbooks.

FIG. 4 depicts an example of a system for managing data for multiple sportsbooks.

FIG. 5 depicts an example of a system for managing funding data.

FIG. 6 depicts a flowchart of an example of a method for submitting a bet through a system for managing multiple sportsbooks.

FIG. 7 depicts a flowchart of an example of a method for managing data for multiple sportsbooks.

FIG. 8 depicts a flowchart of an example of a method for searching records from multiple sportsbooks.

FIG. 9 depicts a flowchart of an example of a method for managing funds in a system for managing multiple sportsbooks.

FIG. 10 depicts an example of a system for managing multiple sportsbooks.

### DETAILED DESCRIPTION OF THE DISCLOSURE

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

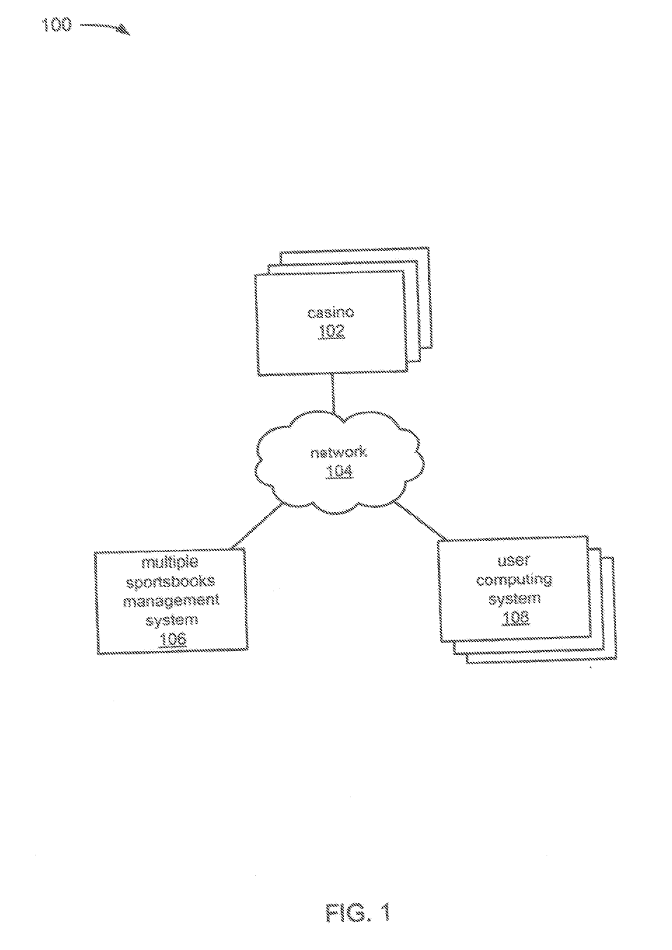

FIG. 1 depicts an example of a system 100 for managing multiple sportsbooks. FIG. 1 includes casino 102, network 104, multiple sportsbooks management system 106 and user computing system 108.

In the example of FIG. 1, casino 102 can be a computing system associated with a gambling or sportsbook establishment, for example, one located in Las Vegas, Atlantic City, Macau, Monte Carlo, a Native American gaming facility on tribal lands, or any known or convenient gambling establishment.

In the example of FIG. 1, network 104 can be practically any type of communications network, such as, by way of example but not limitation, the Internet or an infrastructure network. The term “Internet” as used herein refers to a network of networks which uses certain protocols, such as the TCP/IP protocol, and possibly other protocols such as the hypertext transfer protocol (HTTP) and secure hypertext transfer protocol (HTTPS) for, e.g. hypertext markup language (HTML) documents, extensible markup language (XML) documents, extensible hypertext markup language (XHTML) documents, and documents based on other languages that make up the World Wide Web (the web).

In the example of FIG. 1, multiple sportsbooks management system 106 can be one or more computing systems networked together for the purpose of providing gambling services, in the form of sportsbooks betting, to bettors via a networked computing system.

In the example of FIG. 1, user computing system 108 can be a computer, mobile device, networked computing system, interactive casino gaming machine, or any known or convenient device for accessing a network and placing bets on sporting events.

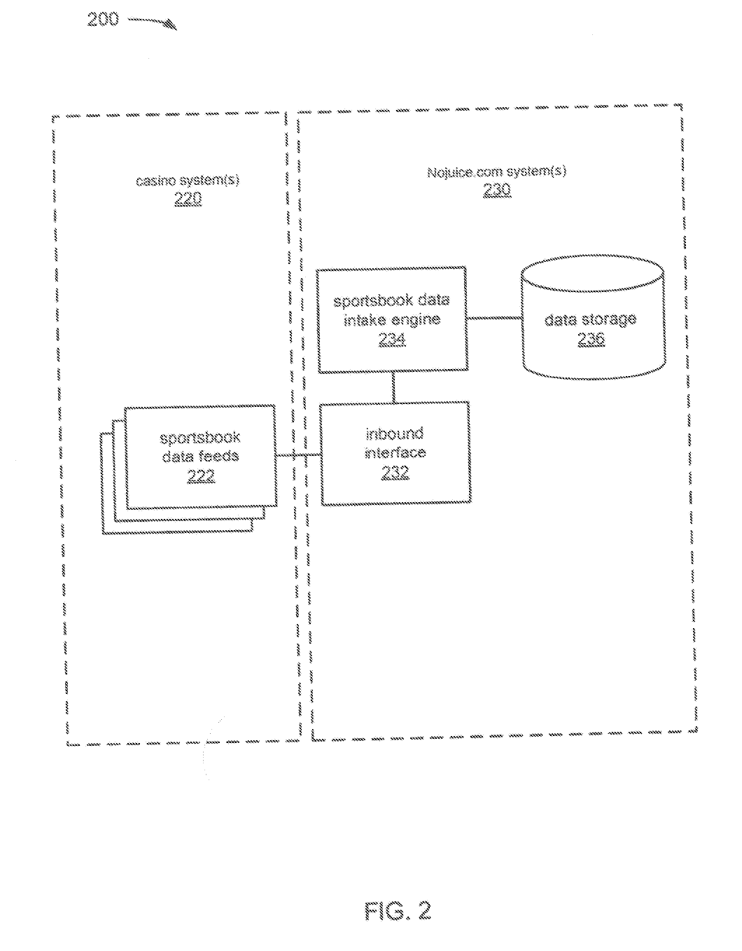

FIG. 2 depicts an example of a system 200 for sports books data intake. FIG. 2 includes sportsbook data feeds 222, inbound interface 232, sportsbook data intake engine 234, and data storage 236.

In the example of FIG. 2, sportsbook data feeds 222 can be a mechanism for transferring data from a data provider to a user of the data. For example, the sportsbook data feeds 222 can be outbound data feeds from a plurality of outside casino computing systems providing the most recent sportsbook data.

In the example of FIG. 2 inbound interface 232 can be a receiver coupled to a computing system for using the sportsbook data. The interface 232 can be part of a multiple sportsbook management system and can receive the sportsbook data and provide it to other processes within the multiple sportsbook management system and/or store the data into a repository.

In the example of FIG. 2 sportsbook data intake engine 234 can be instructions stored in a tangible, non-transitory, memory medium and executed on a processor coupled to the memory. The sportsbook data intake engine 234 can be used to manage the incoming data including storing the data into a repository and/or presenting live data to bettors, if needed.

In the example of FIG. 2 data storage 236 can be a data repository for storing information, particularly data from sportsbooks. Such data can include both data from casinos and data generated by users playing-as-house. As used in this paper, a “repository” can be implemented, for example as software embodied in a physical computer-readable medium on a general-purpose or specific-purpose machine, in firmware, in hardware, in a combination thereof, or in any applicable known or convenient device or system.

The repositories described in this paper are intended, if applicable, to include any organization of data, including tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, FileMaker, Informix, Microsoft Access, Microsoft SQL Server, Microsoft Visual FoxPro, MySQL, and Openoffice.org Base, to name several. However, any known or convenient DBMS can be used.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

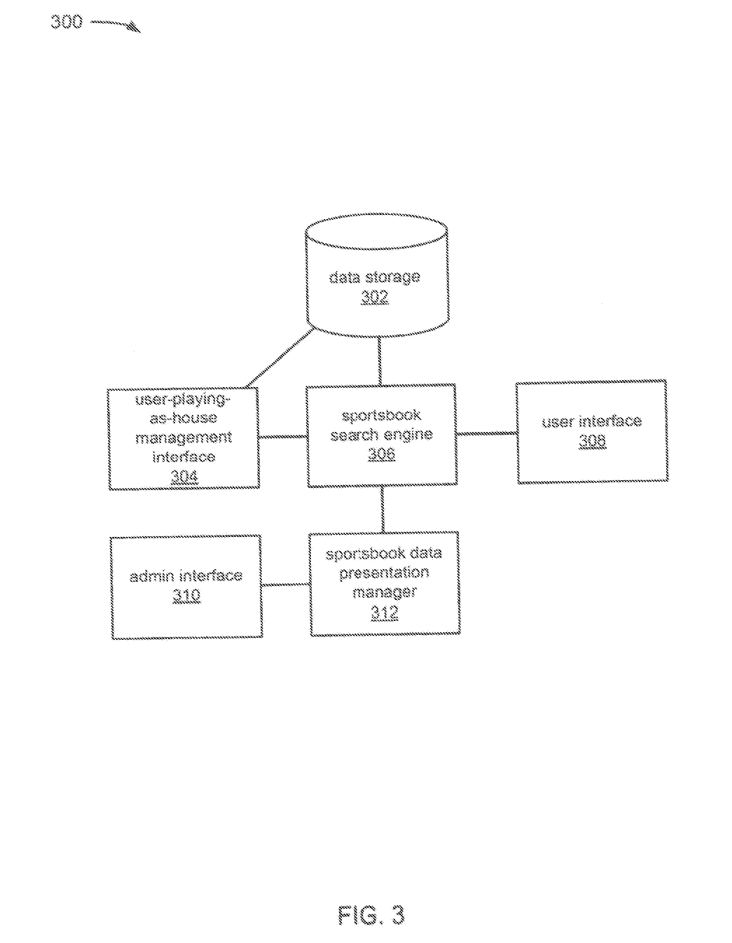

FIG. 3 depicts an example of a system 300 for managing data for multiple sportsbooks. FIG. 3 includes data storage 302, user-playing-as-house management interface 304, sportsbook search engine 306, user interface 308, admin interface 310 and sportsbook data presentation manager 312.

In the example of FIG. 3 data storage 302 can be a data repository, as discussed in reference to FIG. 2.

In the example of FIG. 3, user-playing-as-house management interface 304 can be instructions stored in a tangible, non-transitory, memory medium and executed on a processor coupled to the memory. The user-playing-as-house management interface 304 can be used to receive instructions from a user operating a sportsbook. The interface can receive instructions, e.g. the creation of a betting line in reference to a sporting event. Various sporting events can be tracked and managed by users operating one or more sportsbooks user-playing-as-house management interface 304.

In the example of FIG. 3, sportsbook search engine 306 can be instructions stored in a tangible, non-transitory, memory medium and executed on a processor coupled to the memory. The sportsbook search engine 306 can receive search requests from bettors, users-players-as-house, and any other person searching the system. The search requests can include criteria and the criteria can be used to filter sportsbook data for search results. The search results can then be provided to the bettors, users playing as house, or any other person searching the system.

In the example of FIG. 3 user interface 308 can be instructions stored in a tangible, non-transitory, memory medium and executed on a processor coupled to the memory. The user interface 308 can receive requests from users playing-as-house, bettors, and other persons and return the requested data back to the users.

In the example of FIG. 3, admin interface 310 can be instructions stored in a tangible, non-transitory, memory medium and executed on a processor coupled to the memory. The admin interface 310 can receive instructions from system administrators to, e.g., set the presentation of data provided via sportsbook data presentation manager 312, and perform other tasks of general system administration.

In the example of FIG. 3, sportsbook data presentation manager 312 can be instructions stored in a tangible, non-transitory, memory medium and executed on a processor coupled to the memory. The sportsbook data presentation manager 312 can prepare and format.

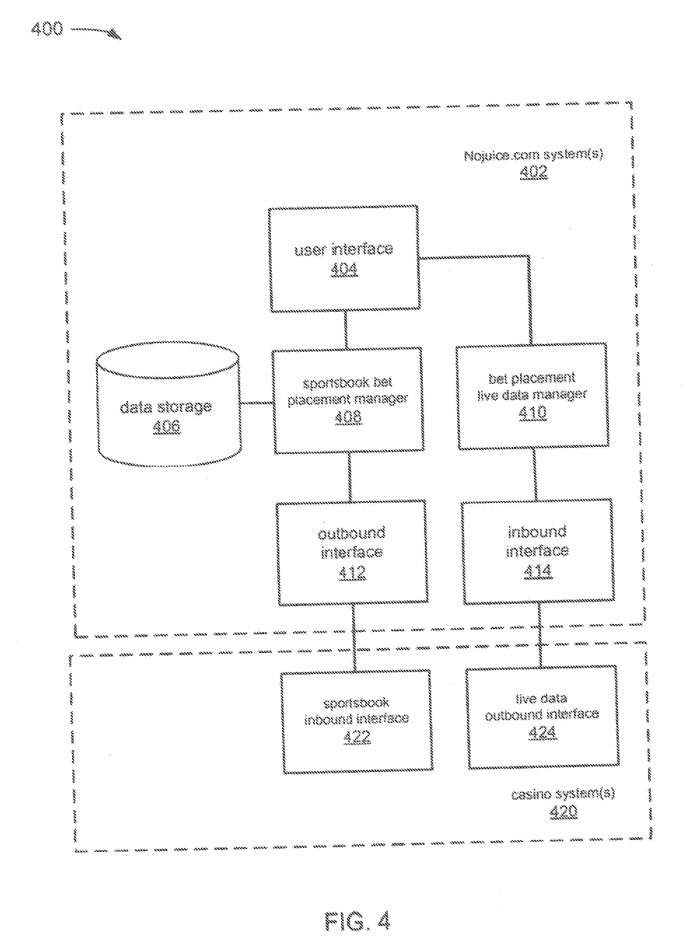

FIG. 4 depicts an example of a system 400 for managing data for multiple sportsbooks. FIG. 4 includes user interface 404, data storage 406, sportsbook bet placement manager 408, bet placement live data manager 410, outbound interface 412, inbound interface 414, sportsbook inbound interface 422 and live data outbound interface 424.

In the example of FIG. 4, user interface 404 can be instructions stored in a tangible, non-transitory, memory medium and executed on a processor coupled to the memory. The user interface can receive a search request and/or instructions from a bettor, user playing-as-house or other person using the system and then provide this information to the sportsbook search engine.

In the example of FIG. 4, data storage 406 can repository as discussed in reference to FIG. 2.

In the example of FIG. 4, sportsbook bet placement manager 408 can be instructions stored in a tangible, non-transitory, memory medium and executed on a processor coupled to the memory operable to enter bets by storing data into the data storage 406.

In the example of FIG. 4 bet placement live data manager 410 can be instructions stored in a tangible, non-transitory, memory medium and executed on a processor coupled to the memory operable to provide live betting data to a bettor as the bettor is making bets.

In the example of FIG. 4, outbound interface 412 can be instructions stored in a tangible, non-transitory, memory medium and executed on a processor coupled to the memory operable to submit a bet to a casino sportsbook.

In the example of FIG. 4, inbound interface 414 can be instructions stored in a tangible, non-transitory, memory medium and executed on a processor coupled to the memory operable to receive wagering data from a casino, racetrack, or other betting establishment.

In the example of FIG. 4, sportsbook inbound interface 422 can be a hardware, software or other systems of a betting establishment computing system.

In the example of FIG. 4 live data outbound interface 424 can be hardware, software, or other systems that can supply data to the inbound interface 414.

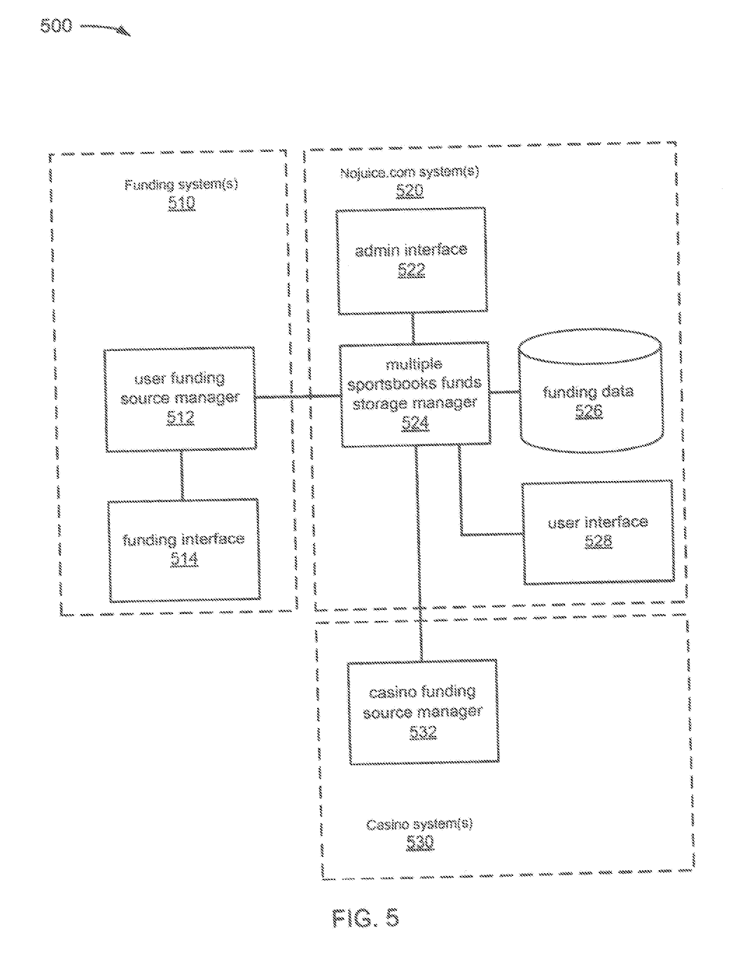

FIG. 5 depicts an example of a system 500 for managing funding data. FIG. 5 includes user funding source manager 512, funding interface 514, admin interface 522, multiple sportsbooks funds storage manager 524, funding data 526, user interface 528, and casino funding source manager 532.

In the example of FIG. 5, user funding source manager 52 can be a bank computing system, credit card management system, other funding management system, e.g. Bank of America, Paypal, or another funds management system.

In the example of FIG. 5, funding interface 514 can be a web interface into a funds management system, e.g. a banking website, a credit card website or other known or convenient interface.

In the example of FIG. 5, admin interface 522 can be instructions stored in a tangible, non-transitory, memory medium and executed on a processor coupled to the memory operable to allow an administrator to adjust the function of multiple sportsbooks funds storage manager 524.

In the example of FIG. 5 multiple sportsbooks funds storage manager 524 can be instructions stored in a tangible, non-transitory, memory medium and executed on a processor coupled to the memory operable to enter records in funding data repository 526 to track financial transactions.

In the example of FIG. 5, funding data 526 can be a repository as discussed in reference to FIG. 2.

In the example of FIG. 5, user interface 528 can be instructions stored in a tangible, non-transitory, memory medium and executed on a processor coupled to the memory operable to make financial transactions such as deposits, withdrawals, and other financial transactions.

In the example of FIG. 5, casino funding source manager 532 can be a system able to receive funding information transmitted in reference to betting information. The betting information is used when placing bets with the casino. Casino funding source manager 532 receives funding through funding interface 514 similarly to user funding source manager 512. In the example embodiment, Casino funding source manager 532 controls funding of casinos and bettors playing as house. When a bet is accepted, casino funding source manager 532 debits user accounts pending outcome of the event. In one implementation, casino accounts are also debited pending the outcome of the event. Once the outcome of an event is determined, casino funding source manager 532 and user funding source manager 512 reconcile user accounts and casino accounts to reflect the outcome.

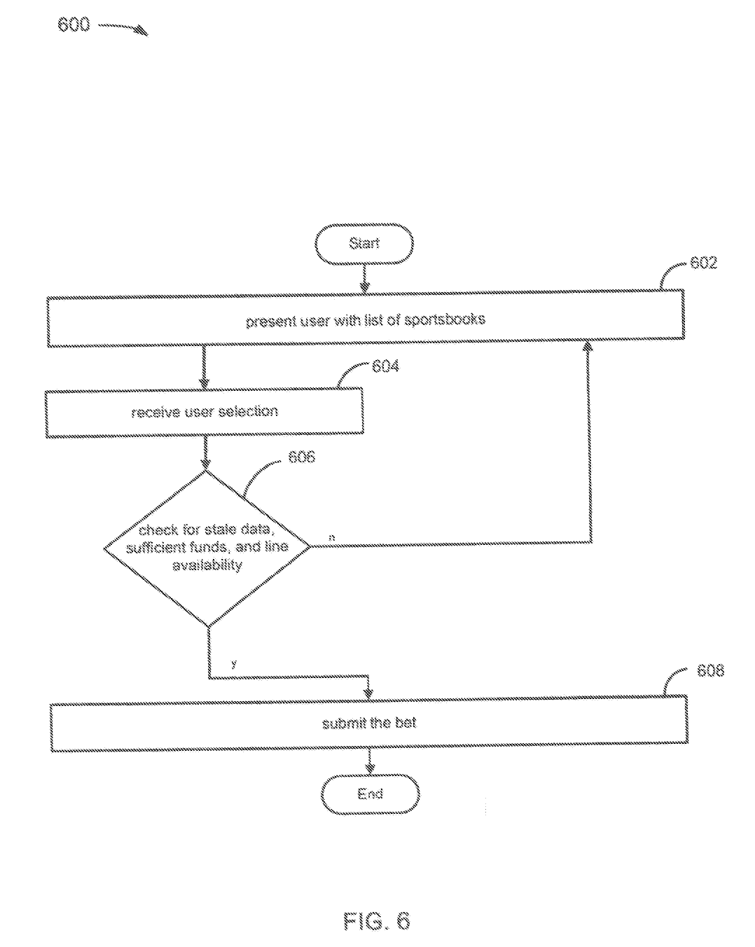

FIG. 6 depicts a flowchart 600 of an example of a method for submitting a bet through a system for managing multiple sportsbooks. The flowchart 600 is presented as a series of modules, however, the modules may be combined and divided and/or reordered to suit the needs of various applications.

In the example of FIG. 6, the flowchart starts at module 602 with present user with list of sportsbooks, events, and/or types of bets. The sportsbooks, events, and/or types of bets can be selected from all of the data in the system, or may be reduced to a smaller sub-set based on criteria and/or knowledge of a bettor in question.

In the example of FIG. 6, the flowchart continues to module 604 with receive user selection. A user may select one or more sportsbooks, events, or types of bets for further inquiry, such as to enter a wager or wagers with the sportsbook.

In the example of FIG. 6, the flowchart continues to decision module 606 and checks for stale data, sufficient funds, and line availability for each wager submitted by the user. If the user has sufficient funds, the line is still available and the data is not stale then the answer is yes. However, if there are any concerns with any items, the concern can be resolved before placing the bet; e.g., a user may need to add funds, may need to be provided more current data, may need to be warned that the currently selected line is no longer available, or warned that the selected line is not the best available line. If the decision at 606 is no, the flowchart proceeds back to module 602 to resolve the concern. If the decision at 606 is yes, then the flowchart proceeds to module 608 with submitting the bet. The bet is submitted to the system and accepted. In at least one embodiment, the accepted bet is layed to the sportsbook associated with the line on which the user placed the bet. Alternatively, the accepted bet is layed to a central sportsbook not associated with the line on which the user placed the bet.

In one embodiment, once a participant, is selected, the system determines a best line associated with the participant. As used herein, the term participant refers to a team, subset of a team, individual player, horse, parlay team, or other entity competing in an event. Specifically, the system compares first wagering data associated with a first data feed with second wagering data associated with a second data feed. The system determines which line of the first wagering data and the second wagering data is more favorable for the selected participant. The system selects the line associated with the more favorable odds, and provides a proposition to the user based on the line with the more favorable lines.

In another embodiment, once a participant is selected, the system determines a first proposition based on wagering data from the first data feed and a second proposition based on wagering data from the second data feed. The first proposition and the second proposition are provided to the user of the user computing device.

In another embodiment, a gambler may make a parlay type bet. In one embodiment, the parlay type bet may be placed based on sportsbook data from a single sportsbook. Alternatively, the parlay type bet may be placed based on sportsbook data from a plurality of sportsbooks.

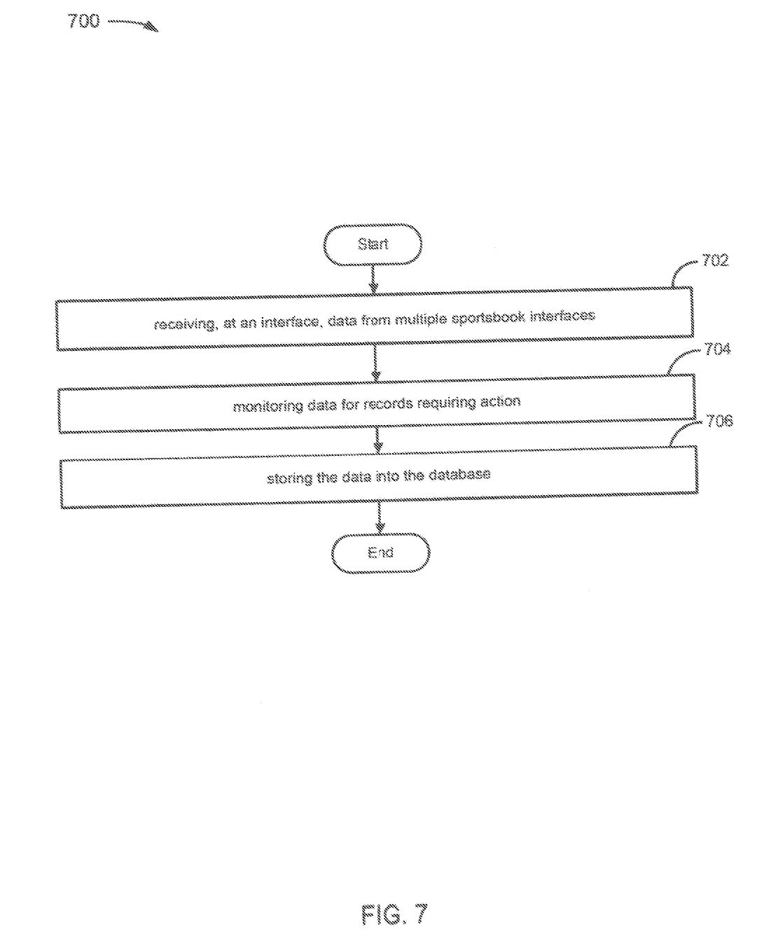

FIG. 7 depicts a flowchart 700 of an example of a method for managing data for multiple sportsbooks. The flowchart 700 is presented as a series of modules, however, the modules may be combined and divided and/or reordered to suit the needs of various applications.

In the example of FIG. 7, the flowchart starts at module 702 with receiving, at an interface, wagering data from multiple sportsbooks interfaces. The data can be in reference to the same sport, or different sports, and will include sportsbook information sufficient for a bettor to make a bet on the book.

In the example of FIG. 7, the flowchart continues to module 704 with monitoring data for records requiring action. As data changes, the data in the repository will need to be updated.

In the example of FIG. 7, the flowchart continues to decision module 706 with storing the data into the database. Data requiring updates can be saved into the repository. Having stored the data in the database, the flowchart terminates.

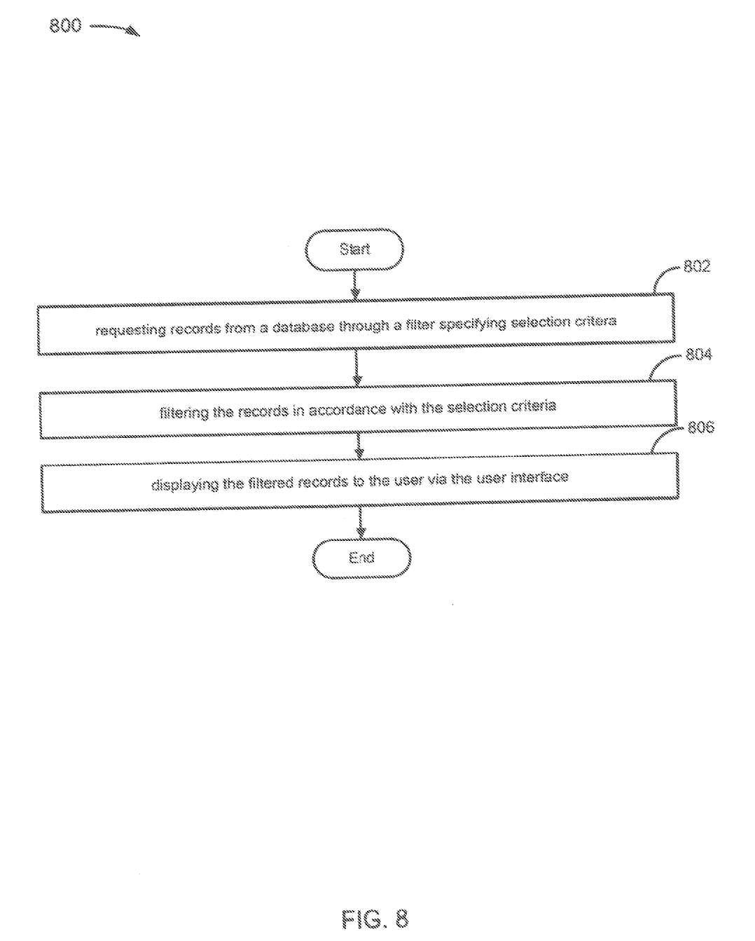

FIG. 8 depicts a flowchart 800 of an example of a method for searching records from multiple sportsbooks. The flowchart 800 is presented as a series of modules, however, the modules may be combined and divided and/or reordered to suit the needs of various applications.

In the example of FIG. 8, the flowchart starts at module 802 with requesting records from a database through a filter specifying selection criteria. The request can be made of the repository using criteria from a bettor specifying sporting events, betting lines, teams, prop bets, individual player outcomes, and types of bets or other search criteria.

In the example of FIG. 8, the flowchart continues to module 804 with filtering the records in accordance with the selection criteria. The records can be filtered by applying the search criteria to the data to produce the filtered records for viewing by the bettor or other user.

In the example of FIG. 8, the flowchart continues to decision module 806 with displaying the filtered records to the user via the user interface. The results can be displayed via a web page, stand-alone application, or any known or convenient system. Having displayed the filtered records to the user via the user interface, the flowchart terminates.

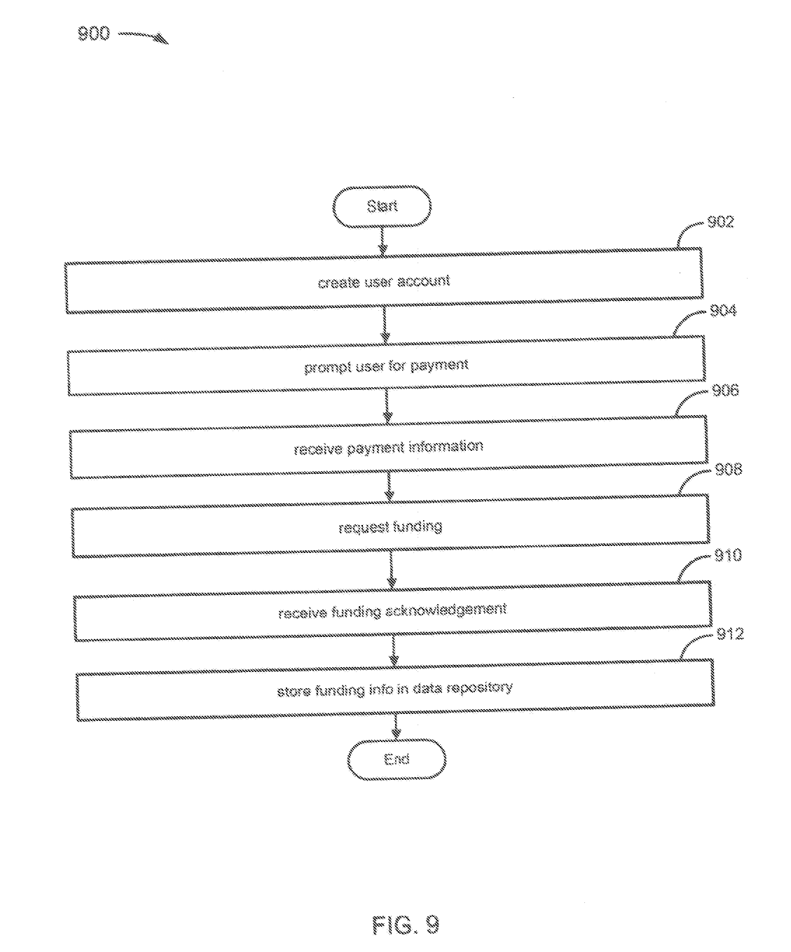

FIG. 9 depicts a flowchart of an example of a method for managing funds in a system for managing multiple sportsbooks. The flowchart 800 is presented as a series of modules; however, the modules may be combined and divided and/or reordered to suit the needs of various applications.

In the example of FIG. 9, the flowchart starts at module 902 with create user account. The account can be created by recording user information into a repository along with a unique identifier associating the user the system and where the user plays-as-house the user can be associated with one or more of his or her own sportsbooks.

In the example of FIG. 9, the flowchart continues to module 904 with prompt user for payment. The user can be asked for, e.g., a bank account, a credit card, or another method of funding.

In the example of FIG. 9, the flowchart continues to module 906 with receive payment information. The payment information can be collected and stored into a repository.

In the example of FIG. 9, the flowchart continues to module 908 with request funding. Information regarding funding can be directly sent to a financial institution, or a message prompting the user to provide such to a financial institution can be provided.

In the example of FIG. 9, the flowchart continues to module 910 with receive funding acknowledgement. This acknowledgement can be sent by the financial institution in the form of a record of the transaction.

In the example FIG. 9, the flowchart continues to decision module 912 with store funding info in data repository. The records can be entered into the repository thereby saving the data. Having stored funding info in the data repository, the flowchart terminates.

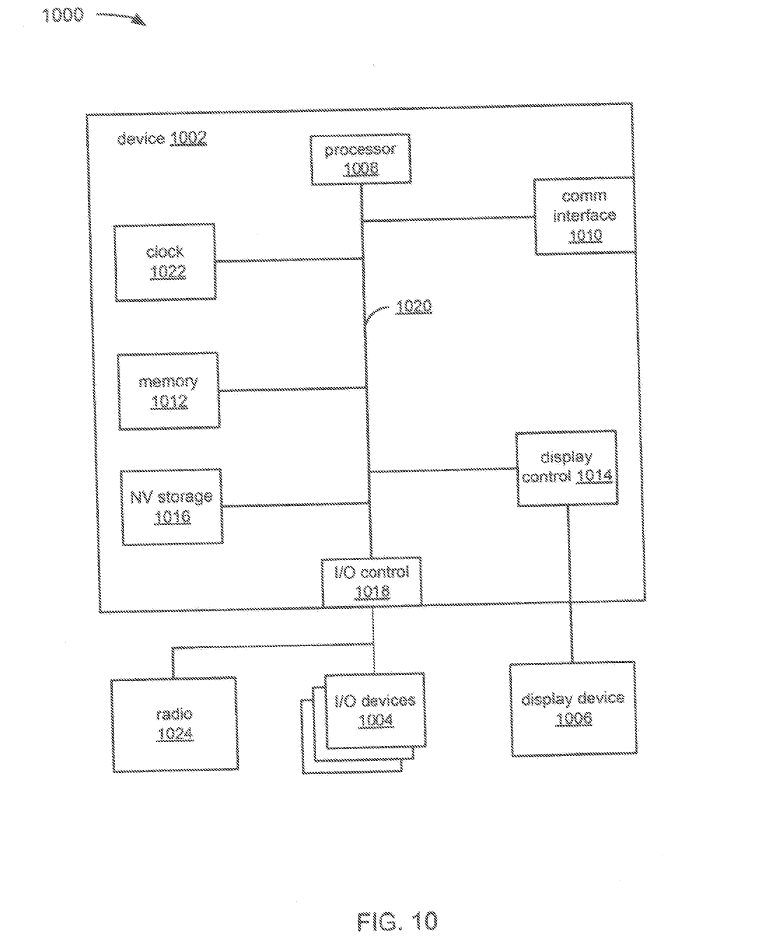

FIG. 10 depicts an example of a system for managing multiple sportsbooks. The system 1000 may be a conventional computer system that can be used as a client computer system, such as wireless client or a workstation, or a server computer system. The system 1000 includes a device 1002, I/O devices 1004, and a display device 1006. The device 1002 includes a processor 1008, a communications interface 1010, memory 1012, displayer controller 1014, non-volatile storage 1016, I/O controller 1018, clock 1022, and radio 1024. The device 1002 may be coupled to or include the I/O devices 1004 and the display device 1006.

The device 1002 interfaces to external systems through the communications interface 1010, which may include a modem or network interface. It will be appreciated that the communications interface 1010 can be considered to be part of the system 1000 or a part of the device 1002. The communications interface 1010 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMA/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 1008 may be, for example, a conventional microprocessor such as an Intel Pentium microprocessor or Motorola power PC microprocessor. The memory 1012 is coupled to the processor 1008 by a bus 1020. The memory 1012 can be Dynamic Random Access Memory (DRAM) and can also include Static RAM (SRAM). The bus 1020 couples the processor 1008 to the memory 1012, also to the non-volatile storage 1016, to the display controller 1014, and to the I/O controller 1018.

The I/O devices 1004 can include a keyboard, disk drives, printers, a scanner, and other input and output devices, including a mouse or other pointing device. The display controller 1014 may control in the conventional manner a display on the display device 1006, which can be, for example, a cathode ray tube (CRT) or liquid crystal display (LCD). The display controller 1014 and the I/O controller 1018 can be implemented with conventional well known technology.

The non-volatile storage 1016 is often a magnetic hard disk, flash memory, an optical disk, or another form of storage for large amounts of data. Some of this data is often written, by a direct memory access process, into memory 1012 during execution of software in the device 1012. One of skill in the art will immediately recognize that the terms “machine-readable medium” or “computer-readable medium” includes any type of storage device that is accessible by the processor 1008.

Clock 1022 can be any kind of oscillating circuit creating an electrical signal with a precise frequency. In a non-limiting example, clock 1022 could be a crystal oscillator using the mechanical resonance of vibrating crystal to generate the electrical signal.

The radio 1024 can include any combination of electronic components, for example transistors, resistors, and capacitors. The radio is operable to transmit and/or receive signals.

The system 1000 is one example of many possible computer systems which have different architectures. For example, personal computers based on an Intel microprocessor often have multiple buses, one of which can be an I/O bus for the peripherals and one that directly connects the processor 1008 and the memory 1012 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1012 for execution by the processor 1008. A typical computer system will usually include at least a processor, memory, and a bus coupling the memory to the processor.

In addition, the system 1000 is controlled by operation system software which includes a file management system, such as a disk operating system, which is part of the operating system software. One example of operating system software with its associated file management system software is the family of operating systems known as Windows® from Microsoft Corporation of Redmond, Wash., and their associated file management system software is the Linux operating system and its associated file management system. The file management system is typically stored in the non-volatile storage 1016 and causes the processor 1008 to execute the various acts required by the operating system to input and output data and to store data in memory, including storing files on the non-volatile storage 1016.

Some portions of the detailed description are presented in terms of algorithms and symbolic representations of operations on data bits within a computer memory. These algorithmic descriptions and representations are the means used by those skilled in the data of processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the link, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMS, and magnetic-optical disks, or any type of media suitable for storing electronic instructions, and each couple to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A computer-implemented method for generating wagers between a user of a user computing device and a multiple sportsbooks system, said method implemented by a host computing device coupled to a memory, said method comprising:
receiving, by the host computing device, a first data feed from a first sportsbook and a second data feed from a second sportsbook, wherein the first data feed includes first wagering data associated with an event and the second data feed includes second wagering data associated with the event;
providing a proposition to the user computing device based at least in part on the first wagering data and the second wagering data; and
generating, by the host computing device, a wager between the user and the multiple sportsbook system, wherein the wager is associated with the proposition.

2. The method of claim 1 further comprising:
receiving, by the host computing device, a selected participant;
determining, based on the first wagering data and the second wagering data, a best proposition associated with the selected participant; and
providing the best proposition to the user computing device.

3. The method of claim 1 further comprising:
receiving, by the host computing device, a selected participant;
determining a first proposition associated with the selected participant based on the first wagering data and a second proposition associated with the selected participant based on the second wagering data; and
providing the first proposition and the second proposition to the user computing device.

4. The method of claim 1 further comprising:
receiving a first selected proposition for a first event based on the first wagering data;
receiving a second selected proposition for a second event based on the second wagering data; and
generating a first wager based on the first selected proposition and generating a second wager based on the second selected proposition.

5. The method of claim 1, wherein the first wagering data is at least one of a point-spread, a line, a type of bet, and odds associated with the event.

6. The method of claim 1 further comprising receiving a third data feed from a third sportsbook, and providing at least one proposition based on the first wagering data, the second wagering data, and the third wagering data.

7. The method of claim 1 further comprising receiving a selected proposition from the user computing device; and
transmitting an alert to the user computing device indicating that another proposition has better odds than the selected proposition.

8. The method of claim 1 further comprising transmitting an alert to the user computing device indicating that the at least one proposition has changed.

9. The method of claim 1 further comprising:
determining available funds associated with a user account;
comparing the available funds associated with the user account with an amount associated with the wager; and
deducting funds equal to the amount of the wager from the user account.

10. The method of claim 9, further comprising:
determining available casino funds associated with a casino account;
comparing the available casino funds with the amount associated with the wager; and
deducting funds equal to the amount associated with the wager from the casino account.

11. The method of claim 10 further comprising automatically reconciling the user account and the casino account based on the outcome of the event.

12. The method of claim 1 further comprising determining whether at least one of the first wagering data and the second wagering data is stale.

13. A host computing device for generating wagers between a user of a user computing device and a multiple sportsbooks system, the host computing device comprising a memory and a processor coupled to the memory, the processor configured to:
receive a first data feed from a first sportsbook and a second data feed from a second sportsbook, wherein the first data feed includes first wagering data associated with an event and the second data feed includes second wagering data associated with the event;
provide at least one proposition to the user computing device based at least in part on the first wagering data and the second wagering data; and
generate a wager between the user and the multiple sportsbook system, wherein the wager is associated with the at least one proposition.

14. The host computing device of claim 13, wherein the processor is further configured to:
receive a selected participant;
determine, based on the first wagering data and the second wagering data, a best proposition associated with the selected participant; and
provide the best proposition to the user computing device.

15. The host computing device of claim 13, wherein the processor is further configured to:
receive a selected participant;
determine a first proposition associated with the selected participant based on the first wagering data and a second proposition associated with the selected participant based on the second wagering data; and
provide the first proposition and the second proposition to the user computing device.

16. The host computing device of claim 13, wherein the processor is further configured to filter the first wagering data and the second wagering data based on criteria input from a user computing device.

17. The host computing device of claim 13, wherein the processor is further configured to:
determine available funds associated with a user account;
compare the available funds associated with the user account with the wager; and
deduct funds equal to an amount of the wager from the user account.

18. The host computing device of claim 13, wherein the processor is further configured to determine whether at least one of the first wagering data and the second wagering data is stale.

19. A computer readable medium having computer-executable instructions for generating wagers between a user of a user computing device and a multiple sportsbooks system, wherein, when executed by a processor, the computer-executable instructions cause the processor to:
receive a first data feed from a first sportsbook and a second data feed from a second sportsbook, wherein the first data feed includes first wagering data associated with an event and the second data feed includes second wagering data associated with the event;
provide at least one proposition to the user computing device based at least in part on the first wagering data and the second wagering data; and
generate a wager between the user and the multiple sportsbook system, wherein the wager is associated with the at least one proposition.

20. A computer readable medium in accordance with claim 19, wherein the computer-executable instructions further cause the processor to:
receive a selected participant;
determine, based on the first wagering data and the second wagering data, a best proposition associated with the selected participant; and
provide the best proposition to the user computing device.

21. A computer readable medium in accordance with claim 19, wherein the computer-executable instructions further cause the processor to:
receive a selected participant;
determine a first proposition associated with the selected participant based on the first wagering data and a second proposition associated with the selected participant based on the second wagering data; and
provide the first proposition and the second proposition to the user computing device.

22. A computer readable medium in accordance with claim 19, wherein the computer-executable instructions further cause the processor to:
determine available funds associated with a user account;
compare the available funds associated with the user account with the wager; and
deduct funds equal to an amount of the wager from the user account.

23. A computer readable medium in accordance with claim 19, wherein the computer-executable instructions further cause the processor to determine whether at least one of the first wagering data and the second wagering data is stale.
